(19) United States
(12) Patent Application Publication
(10) Pub. No.: US 2013/0125732 A1
(43) Pub. Date: May 23, 2013

(54) Methods to Create New Melodies and Music From Existing Source

(71) Applicant: Paul Nho Nguyen, Plano, TX (US)

(72) Inventor: Paul Nho Nguyen, Plano, TX (US)

(21) Appl. No.: 13/301,749

(22) Filed: Nov. 21, 2011

(51) Int. Cl. G10H 7/00

(52) U.S. Cl. 84/609

(57) ABSTRACT

Given an existing piece of music, represented in any form such as midi, sound frequencies, etc, but most notably in the form of sheet music and musical scores and music-xml, methods can be applied to the existing music to create an entirely new sound. While the traditional transposition of music shifts all notes from one key signature to another and essentially produces the same melody in a different key, this method transposes all the notes of an existing composition using a totally different set of transposition rules to produce unique new music.

### TECHNICAL FIELD

Music Composition

### BACKGROUND ART

It is common in music composition to transpose a musical composition from one key signature to another. This common transposition method makes a change to all the notes by shifting all notes in the composition from one key to another, yet keeping the relationship of all the notes relative to each other the same. This traditional method of transposition does not alter the melody at all, rather, it puts the same melody into another key signature. This patent application proposes a different set of rules for transposition, rules that produce new music and melodies that are pleasant to the ear.

### SUMMARY OF INVENTION

1. Technical Problem

A great hindrance to a professional music composer is writer's block, and the inability to create melodic ideas that are unusual and counter intuitive to his or her style of composition. The great hindrance of any beginner composer is the lack of knowledge in the music arts, and lack of ability to comprehend and the complexities of creating sophisticated music that often requires years of experience and learning. Yet most people have the ability to judge and enjoy music. Thus, both the professional and the beginner song writer need a method or tool to generate unique music, and to simply use their listening skills to determine if a piece of generated music is useful for inclusion into their composition.

2. Solution to Problem

One solution to the problem of creating new ideas for music melodies is the subject of this application. Given any existing piece of music, represented in any form such as midi, musicxml, sound frequencies, etc, but most notably in the form of sheet music and musical scores, a method can be applied to the existing music to create an entirely new sound. Unlike the traditional transposition of music which shifts all notes from one key signature to another, this method transposes all the notes of an existing composition in a repeatable and consistent manner, but using a totally different set of transposition rules, herein this method is described as “X-Transposition”.

### Advantageous Effects of Invention

The music X-Transposing methods described herein may be carried out in any manner, either manually, on paper, with hardware, or with software. The result of X-Transposing an existing music composition using a combination of techniques claimed in this paper, often results in many unique new melodies that are pleasant to the ear. The process of X-Transposing music is quick using software. Once new music is generated using X-Transposing, playback of the music can reveal if the new music is pleasant or not. For example, if the new music is represented in the form of sheet music, playback of the generated output music using sheet-music-to-midi can be done using any off-the-shelf music composition software. Thus the analysis of whether a particular output of X-Transposition sounds good or not, can be done quickly and effectively. So when implemented with software, the music X-Transposition methods not only provide ideas for music melodies, but also does it quickly. The idea of X-Transposition leverages the fact that if a piece of existing music has structure and design that is effective, by simply changing the pitch of each note, the structure and design of the output music is also effective.

### BRIEF DESCRIPTION OF DRAWINGS

FIG. 1: A User-Defined Static Notes Mapping Table (SNMT)

FIG. 2: Another User-Defined Static Notes Mapping Table (SNMT)

FIG. 3: Original Music Passage

FIG. 4: Result of X-Transposition of FIG. 3 using SNMT from FIG. 1

FIG. 5: Alternate Result of X-Transposition of FIG. 3 using SNMT from FIG. 1

FIG. 6: Example of C-Major Major-Scale-Degree mapping-rule

FIG. 7: X-Transposition of Original Music Using SNMT from FIG. 6

FIG. 8: Major-Scale-Degree mapping-rule MSD-4971 for the key of C, with examples of Two Variants of the mapping-rule

FIG. 9: Original Music Sample

FIG. 10: Reverse sheet music (reversing music shown in FIG. 8)

### DESCRIPTION OF EMBODIMENTS

The main concept described in this application has to do with X-Transposing existing music. X-Transposing is the concept of creating new music or new music ideas by taking an existing piece of music, and replacing each of its individual notes (pitch) with a different note (pitch), whereby the rules for replacing notes is specified by a mapping-rule. The mapping-rule basically is a set of rules that maps any input note to a corresponding output note. The establishment of the mapping-rule is the first step needed in X-Transposition, either a static rule, called the Static Notes Mapping Table (the SNMT), or dynamic rules as discussed in one of the methods herein.

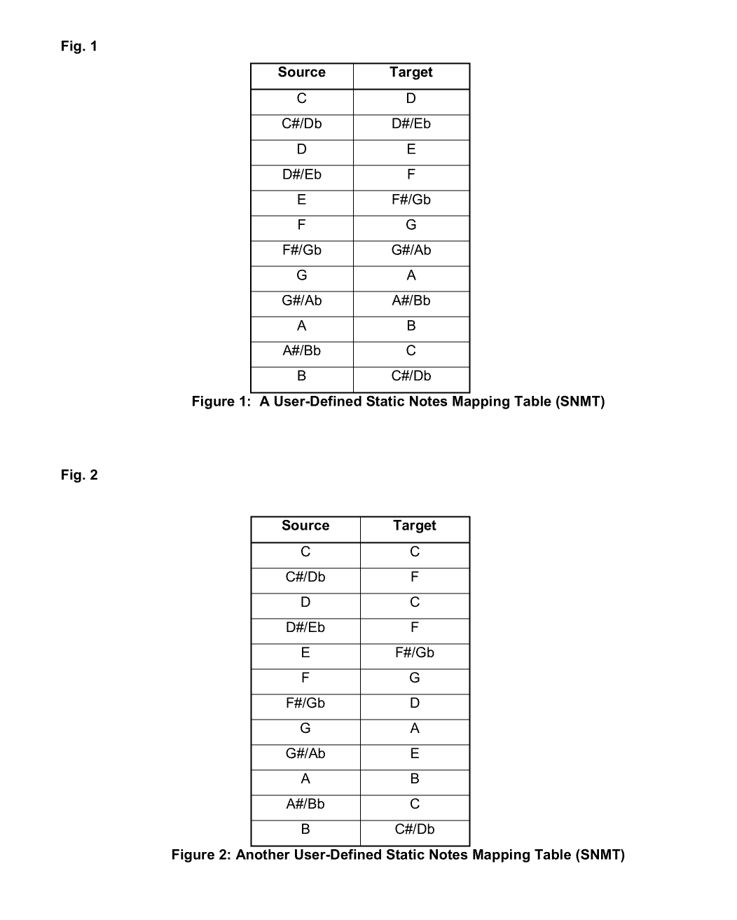

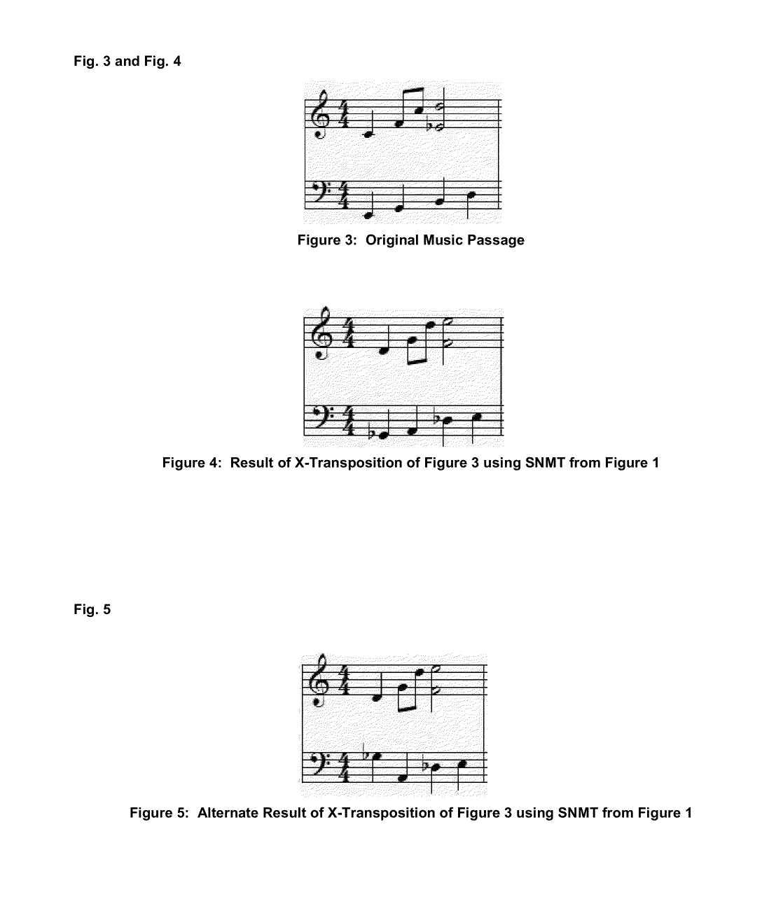

METHOD 1: One-Octave X-Transposition. At the core of the method to X-Transpose music is first, to make a one-to-one mapping of the 12 notes of the chromatic scale (the input notes) to 12 other notes (the output notes) which are also in the same set of notes from the chromatic scale. An example of a user-defined mapping-rule is shown in FIG. 1. This static mapping-rule is referred to as the Static Notes Mapping Table (SNMT). Each SNMT is considered to be a single “mapping-rule” and includes 12 individual mappings that are used to map the notes from an existing composition (Source) to notes of the resulting generated composition (Target). The SNMT can be configured to map the 12 chromatic step notes to any of the other 12 notes, including the mapping of a note to itself (example in FIG. 2), and mapping of two or more notes to the same note (example also in FIG. 2).

Once an SNMT is obtained, the SNMT rules for conversion is applied on an existing piece of music. Each (Source) note of the existing music is converted into the corresponding Target note following the mapping-rules of a chosen SNMT. The music that results from the X-Transposition retains its structure, but the new composition's notes are of different pitch than the original composition. FIG. 4 illustrates the new music that is produced when the SNMT table from FIG. 1 is used to X-Transpose the music passage shown in FIG. 3. This X-Transposition process can be applied to an entire music composition to produce a new-sounding composition. The application of multiple different SNMTs to the same input music composition produces multiple new compositions. The newly created music can itself be X-Transposed again using the same SNMT or a different SNMT mapping.

FIG. 5 represents an alternate result of the application of FIG. 1 SNMT to the original work shown in FIG. 3. Note that the One-Octave Transposition method leaves creative wiggle room to allow a particular note or notes in the resulting output (the new music) to be placed in any higher or lower octave, thus enhancing the potential effect and variability of the new music. In FIG. 5, the first quarter note of the 2^{nd} staff (the G-flat) is shown one octave higher than in FIG. 3. Because a note played an octave higher or lower may have a large impact on the melody, this method of X-Transposing limiting the SNMT to 12 step-notes without regard to octave information of the input note, allows the user to freely use any algorithm to randomly or purposely raise or lower an output note by one or more octaves.

The quality of the generated composition that results from performing the X-Transposition on an input music composition is highly dependent on which mapping-rule (SNMT) is used. The number of possible different SNMTs given that 12 input notes can map to any of the 12 output notes is 8,916,100,448,256 unique mapping-rules. It is discussed next that certain mapping-rules are more useful than others because some have a tendency to produce pleasant new melodies while others do not, while others produce output melodies that sound very similar to the original melody and thus are less useful.

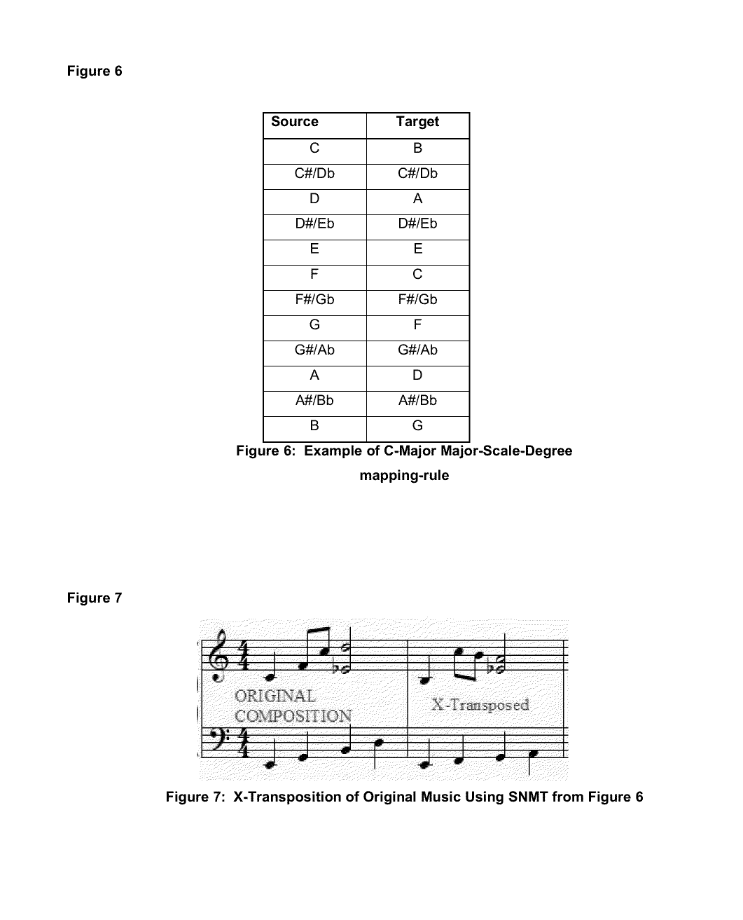

METHOD 2: One-Octave X-Transposition With Adherence to the Scale Degrees of a Key Signature (Major-Scale-Degree mapping-rules for a key signature). As noted earlier, given there are 12 different input notes that may be mapped to 12 different output notes, the number of possible SNMT mapping-rules are huge (8,916,100,448,256). Therefore, focus of this technique is on those SNMT mapping-rules that map a major key's 7 scale-degrees to each other. Each of the major key signatures has 7 scale-degree notes that comprise the key's major scale, and 5 non-scale-degree notes. An additional mapping criteria of this technique is that no two Source notes in a mapping-rule can map to the same Target note. The SNMT mapping of scale-degree to scale-degree tends to produce useful and pleasant new sounds. This concept applies to any of the major key signatures, but the example here focuses on the C-major key signature. An example of these mappings is shown in FIG. 6. Note in this example that all 7 of the Source scale-degree notes (C, D, E, F, G, A, B) map to another scale-degree note (B, A, E, C, F, D, G) and not to a non-scale-degree-note (C#, D#, F#, G#, A#). For this method, the 5 non-scale-degree notes are mapped either to themselves, or to scale-degree notes or non-scale-degree notes. FIG. 7 shows an example of original music that was X-Transposed using the the SNMT mapping-rule presented in FIG. 6.

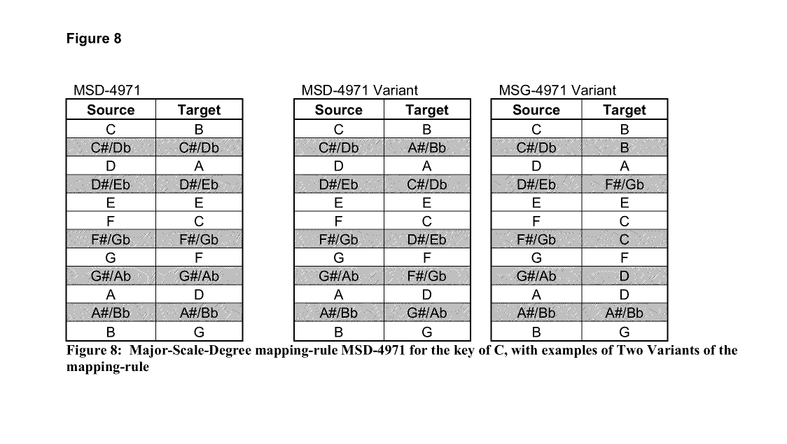

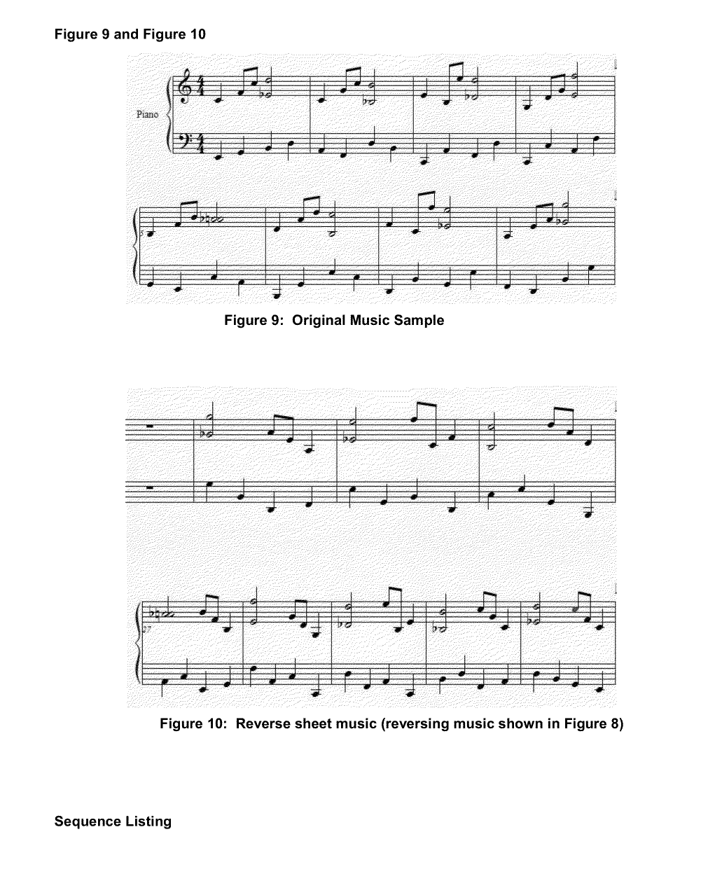

As such, the total number of these mapping-rules is 5,040 which are named the Major-Scale-Degree mapping-rules for a given key signature, and they form a unique subset of the 8,916,100,448,256 possible mapping-rules, and can uniquely be named as MSD-1 through MSD-5040 for that key signature. The algorithm below called EnumerateTheMSD_SNMT_mapping_rules_for_the_key_of_C( ), when executed, assigns the names of these 5,040 Major-Scale-Degree mapping-rules for the key of C. The assignment of names to 5,040 Major-Scale-Degree mapping-rules for the other key signatures can be done by simply changing the ‘C’ in the algorithm below with the Tonic note of the desired key signature, the ‘D’ with the with Supertonic, the ‘E’ with the Mediant, the ‘F’ with the Subdominant, the ‘G’ with the Dominant, the ‘A’ with the Submediant, and the ‘B’ with the Leading Note. For these 5,040 mapping-rules, the 5 non-major-scale degree input notes of these mapping-rules map to themselves, but alternately can map into any of the 12 notes of the chromatic scale, forming variants of the 5,040 Major-Scale-Degree mapping-rules. FIG. 8 shows one of the 5,040 Major-Scale-Degree mapping-rules for the key of C, and two variants of the same mapping rule that each have modified mappings of the non-scale-degree notes.

void EnumerateTheMSD_SNMT_mapping_rules_for_the_key_of_C(void){
int MSD_SNMT_NUMBER = 1, ii, jj, kk, ll, mm, nn, oo; char note[7];
for (ii = 0; ii < 7; ii++){

```
memset(note, ‘0’, 7);
switch (ii) { case 0: note[0]=‘C’; break; case 1: note[0]=‘D’; break; case 2: note[0]=‘E’; break;
  case 3: note[0]=‘F’; break; case 4: note[0]=‘G’; break; case 5: note[0]=‘A’; break;
  case 6: note[0]=‘B’; break;}
for (jj = 0; jj < 7; jj++) {
```

switch (jj){

case 0: note[1]=‘C’; break; case 1: note[1]=‘D’; break; case 2: note[1]=‘E’; break;
case 3: note[1]=‘F’; break; case 4: note[1]=‘G’; break; case 5: note[1]=‘A’; break;
case 6: note[1]=‘B’; break;}

if (note[1]==note[0]){continue;}

for (kk = 0; kk < 7; kk++) {

switch (kk) { case 0: note[2]=‘C’; break; case 1: note[2]=‘D’; break;

case 2: note[2]=‘E’; break; case 3: note[2]=‘F’; break;
case 4: note[2]=‘G’; break; case 5: note[2]=‘A’; break; case 6: note[2]=‘B’; break;}

if ((note[2]==note[0]) ∥ (note[2] == note[1]) ) { continue; }

for (ll = 0; ll < 7; ll++) {

switch (ll) { case 0: note[3]=‘C’; break; case 1: note[3]=‘D’; break;

case 2: note[3]=‘E’; break; case 3: note[3]=‘F’; break;
case 4: note[3]=‘G’; break; case 5: note[3]=‘A’; break;
case 6: note[3]=‘B’; break; }

if ((note[3]==note[0]) ∥ (note[3] == note[1]) ∥ (note[3]==note[2] )) { continue; }

for (mm = 0; mm < 7; mm++) {

```
switch (mm)
{ case 0: note[4]=‘C’; break; case 1: note[4]=‘D’; break; case 2: note[4]=‘E’; break;
  case 3: note[4]=‘F’; break; case 4: note[4]=‘G’; break; case 5: note[4]=‘A’; break;
  case 6: note[4]=‘B’; break; }
if ((note[4]==note[0]) ∥ (note[4] == note[1]) ∥ (note[4]==note[2] ) ∥
```

(note[4]==note[3]) ) { continue; }

for (nn = 0; nn < 7; nn++){

switch (nn) {

case 0: note[5]=‘C’; break; case 1: note[5]=‘D’; break; case 2: note[5]=‘E’; break;
case 3: note[5]=‘F’; break; case 4: note[5]=‘G’; break; case 5: note[5]=‘A’; break;
case 6: note[5]=‘B’; break; }

if ((note[5]==note[0]) ∥ (note[5] == note[1]) ∥ (note[5]==note[2]) ∥

(note[5]==note[3]) ∥ (note[5] ==note[4]) ) { continue; }

for (oo = 0; oo < 7; oo++) {

switch (oo) {

case 0: note[6]=‘C’; break; case 1: note[6]=‘D’; break; case 2: note[6]=‘E’; break;
case 3: note[6]=‘F’; break; case 4: note[6]=‘G’; break; case 5: note[6]=‘A’; break;
case 6: note[6]=‘B’; break; }

if ((note[6]==note[0]) ∥ (note[6] == note[1]) ∥ (note[6]==note[2]) ∥

(note[6]==note[3]) ∥ (note[6] ==note[4]) ∥ (note[6]==note[5]) ) { continue; }

printf(“ MSD-%d: maps input notes C D E F G A B to output notes %c %c %c %c %c %c %c\n”,

MSD_SNMT_NUMBER++, note[0], note[1], note[2], note[3], note[4], note[5], note[6]);

} } } } } } } }

METHOD 3: Full-Range X-Transposition. Another method to X-transpose an existing composition is to use a mapping-rule that covers the entire range of notes possible for the musical instrument. For example, for a piano, the mapping-rule can map all 88 steps/notes on the music scale to 88 other steps/notes, thus creating a more firm mapping and a different result than an X-Transposition using method 1. When the Full-Range X-Transposition is applied to an existing composition, the notes of the original composition are swapped on a one-for-one basis as specified by the Full-Range mapping-rule mappings. A software implementation of this method would allow the user to specify or configure the Full-Range mapping-rule used for X-transposition.

METHOD 4: Dynamic X-Transposition. Another method of X-Transposing is to not apply a static mapping (such as an SNMT) to an entire composition, but allow for different rules to be applied to each note. One such method would be to adjust a note up or down by one or more major scale degrees depending on certain parameters, one of which could be the distance in half-steps between the current note under processing and the previous note.

METHOD 5: Reversing music and representing it in sheet music or score. Given a piece of music, whether is is in the form of sheet music or live music, discriminate each individual note and produce a reverse of that music in the form of sheet music. The length and tone of each note is preserved. If ties are present in the sheet music, they would also be present in the reversal of the sheet music. Everything else stays the same including time signature, clef, etc. FIG. 13 illustrates this in the form of sheet music. FIG. 13 is the reversed music for the music shown in FIG. 8.

### EXAMPLES

### Example 1

### Example 2

Examples are embedded in the description above

### INDUSTRIAL APPLICABILITY

Concepts may be used in the music composition industry.

### REFERENCE SIGNS LIST

Reference to Deposited Biological Material

Sequence Listing Free Text

Citation List

Patent Literature

Non Patent Literature

1. A method of generating new music and melodies, comprising: taking an existing music composition as an input, and producing a new music composition by transposing each and every individual note's pitch of the input music to another pitch and the new note becomes part of the new music composition, and whereby the transposing of the input note to the corresponding output note is done in a consistent manner that is specified by a mapping-rule, where the mapping-rule is a set of rules for converting each possible input-note's pitch to an output-note pitch.

2. A method according to claim 1, further comprising: the mapping-rule used for converting input-note to output-note disregards octave information, classifies each input-note and each output-note as one of the 12 unique notes of the chromatic scale, and contains 12 one-to-one static mappings which establish the rules for converting each possible input-note to an output-note and allows every note of the input music to be converted to the mapping-rule's specified output-note consistently, and where the output-notes that make up the new composition may be placed on any octave higher or lower than the original input-notes.

3. A method according to claim 2, further comprising: the use of static 12-note mapping-rules that take the key signature of the input music composition into consideration and meets the criteria of mapping the 7 major-scale-degree notes of the key signature only to one of the same key's 7 major-scale-degree notes as an output, with the additional criteria that no two major-scale-degree input notes within the mapping-rule can map to the same major-scale-degree output note, thus these resulting mapping-rules do not allow mapping or converting any of the 7 major-scale-degree notes in the input music to any of the 5 non-major-scale-degree notes of the key signature, and the total number of these mapping-rules is 5,040 and this set of mapping-rules is named the Major-Scale-Degree mapping-rules for that key signature, and they form a unique subset of the 8,916,100,448,256 possible 12-note mapping-rules, and can uniquely be named as MSD-1 through MSD-5040 for a particular key signature; and for these 5,040 mapping-rules, each of the 5 non-major-scale-degree input notes of these mapping-rules map to themselves, or, if they are mapped to any of the other 12 notes of that key signature, form a variant of a Major-Scale-Degree mapping-rule.

4. A method according to claim 1, further comprising: the mapping-rule for converting input-notes to output-notes does factor octave value and thus includes all possible mappings for the target musical instrument range, such as a piano, where the mapping-rule contains 88 possible input-note pitches each of which are mapped to an output-note pitch which is also in the range of 88 pitches.

5. A method according to claim 1, further comprising: the mapping-rule of input-notes to output-notes is not static as defined by a static mapping-rule, but is defined on the fly, applying rules to raise or lower a note by one or more scale degrees or whole or half steps depending on certain parameters, one of which is the number of half-steps between the current note under processing and the previous note.

6. A method to assist in song-writing, comprising: given a music composition in any form where the individual notes are distiguishable such as in sheet music, reverse the music starting with the last measure of the music composition, and present the result of the reversal as sheet music.
